(19) United States
(12) Patent Application Publication
(10) Pub. No.: US 2009/0234048 A1
(43) Pub. Date: Sep. 17, 2009

(54) Pigment dispersion paste for electrodeposition coating compositions, and electrodeposition coating composition

(76) Inventors: Kiyoshi Kato, Hiratsuka-shi (JP); Naoyuki Yoshikawa, Hiratsuka-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/382,337

(22) Filed: Mar. 13, 2009

(30) Foreign Application Priority Data
Mar. 14, 2008 (JP) 2008-65108

(51) Int. Cl. C08L 1/00

(52) U.S. Cl. 524/35

(57) ABSTRACT

The present invention provides a pigment dispersion paste with improved storage stability, and an electrodeposition coating composition that enables energy saving in electrodeposition coating equipment and a reduction in the amount of electrodeposition coating equipment.

The pigment dispersion paste of the present invention contains (i) a pigment-dispersing resin, (ii) a pigment component, (iii) a cellulose (A), (iv) a hydroxyalkyl imidazoline compound (B) and/or a compound (C), and (v) water;

the pigment dispersion paste containing, per 100 parts by mass of the solids of the pigment-dispersing resin, 0.1 to 1,000 parts by mass of the pigment component, 0.1 to 25 parts by mass of the cellulose (A), 0.1 to 5 parts by mass of a hydroxyalkyl imidazoline compound (B) and/or 0.1 to 5 parts by mass of a compound (C); and

the pigment dispersion paste having, when adjusted to a solids concentration of 40 mass %, an TI value of 1.8 to 4.0 as measured by the pigment test method of JIS K 5101-6-2:

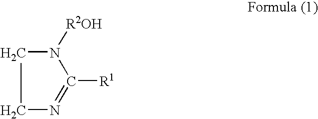

wherein R¹ is a C₆₋₃₂ hydrocarbon group and R² is a C₂₋₆ alkylene group;

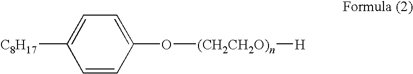

wherein n is an integer from 11 to 16.

### TECHNICAL FIELD

The present invention relates to a pigment dispersion paste for electrodeposition coating compositions that has excellent storage stability, and an electrodeposition coating composition that enables energy saving in coating equipment and reduction in the amount of coating equipment.

### BACKGROUND ART

Electrodeposition coating compositions are widely used as undercoating compositions for metal products, such as automobile bodies, because of their excellent coating operability and good anti-corrosion properties. Pigment dispersion pastes for use in such electrodeposition coating compositions are usually stored in tanks, or placed in drums and stored in warehouses, after production. The pastes must be stirred at regular intervals to avoid pigment settling, which may cause problems in use.

In particular, during shipment to overseas coating facilities, pigment dispersion pastes in drums are allowed to remain unstirred for a long period of time. Improvement of the storage stability of pigment dispersion pastes is therefore of urgent necessity.

Moreover, electrodeposition coating compositions are usually circulated or stirred with pumps even during recesses, nights, or holidays, to prevent pigment settling. The installation and maintenance of equipment for such circulation or stirring require an enormous amount of cost, which creates a demand for an electrodeposition coating composition that enables energy saving in coating equipment and reduction in the amount of equipment.

Japanese Unexamined Patent Publication No. 2004-123942 discloses an electrodeposition coating composition that is substantially free from pigment settling even if it is stored without stirring, the composition containing carbon black as a pigment and a liquid tin catalyst as a curing catalyst.

Japanese Unexamined Patent Publication No. 2005-247892 discloses an electrodeposition coating composition with excellent settling stability containing a pigment and a pigment-settling prevention agent selected from the group consisting of fatty acids, fatty acid derivatives, amine compounds, and mixtures of one or more thereof. In addition, Japanese Unexamined Patent Publications No. 2006-111699 and No. 2008-38056 disclose pigment dispersion pastes for electrodeposition coating compositions containing cellulose composites, and the electrodeposition coating compositions.

In the disclosed inventions, however, the pigment dispersion pastes have insufficient storage stability and therefore settle or agglomerate when they are subjected to severe conditions for a long period of time; and when stirring and circulation of coating compositions containing such pigment dispersion pastes are stopped during holidays or nights, the coating compositions settled cannot be sufficiently re-dispersed, sometimes resulting in poor finish of the coating films. In view of such a situation, an electrodeposition coating composition that exhibits good re-dispersibility even when stirring and circulation of the coating composition are stopped during holidays or nights is desired.

### DISCLOSURE OF THE INVENTION

### Problems to be Solved by the Invention

An object of the present invention is to provide a pigment dispersion paste for electrodeposition coating compositions that has excellent storage stability. Another object of the present invention is to provide an electrodeposition coating composition that has excellent re-dispersibility and excellent stability even when stirring and circulation of the coating composition are stopped during recesses, holidays, or nights, and that is usable with various colors.

### Means for Solving the Problems

The present inventors conducted extensive research to solve the above problems, and as a result, found that the above objects can be achieved by a pigment dispersion paste for electrodeposition coating compositions, the paste comprising a pigment-dispersing resin, a pigment component, a cellulose (A), a hydroxyalkyl imidazoline compound (B) and/or a compound (C), and water; and an electrodeposition coating composition comprising the pigment dispersion paste.

The present invention provides the following pigment dispersion paste and electrodeposition coating composition.

Item 1. A pigment dispersion paste for electrodeposition coating compositions, comprising (i) a pigment-dispersing resin, (ii) a pigment component, (iii) a cellulose (A), (iv) a hydroxyalkyl imidazoline compound (B) and/or a compound (C), and (v) water;

the pigment dispersion paste comprising, per 100 parts by mass of the solids of the pigment-dispersing resin, 0.1 to 1,000 parts by mass of the pigment component, 0.1 to 25 parts by mass of the cellulose (A), and 0.1 to 5 parts by mass of the hydroxyalkyl imidazoline compound (B) represented by Formula (1) and/or 0.1 to 5 parts by mass of the compound (C) represented by Formula (2); and

the pigment dispersion paste, when adjusted to a solids concentration of 40 mass %, having an TI value of 1.8 to 4.0 as measured by the pigment test method of JIS K 5101-6-2:

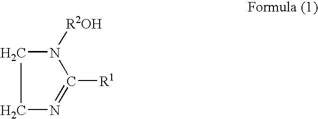

wherein R¹ is a C₆₋₃₂ hydrocarbon group and R² is a C₂₋₆ alkylene group;

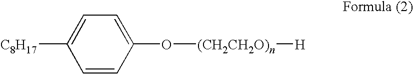

wherein n is an integer from 11 to 16.

Item 2. The pigment dispersion paste according to Item 1, wherein the pigment dispersion paste comprises, per 100 parts by mass of the solids of the pigment-dispersing resin, 0.1 to 1,000 parts by mass of the pigment component, 0.1 to 25 parts by mass of the cellulose (A), and 0.1 to 5 parts by mass of the hydroxyalkyl imidazoline compound (B) represented by Formula (1); and wherein the pigment dispersion paste, when adjusted to a solids concentration of 40 mass %, has an TI value of 1.8 to 4.0 as measured by the pigment test method of JIS K 5101-6-2.

Item 3. The pigment dispersion paste according to Item 1, wherein the pigment dispersion paste comprises, per 100 parts by mass of the solids of the pigment-dispersing resin, 0.1 to 1,000 parts by mass of the pigment component, 0.1 to 25 parts by mass of the cellulose (A), and 0.1 to 5 parts by mass of the compound (C) represented by Formula (2); and wherein the pigment dispersion paste, when adjusted to a solids concentration of 40 mass %, has an TI value of 1.8 to 4.0 as measured by the pigment test method of JIS K 5101-6-2.

Item 4. The pigment dispersion paste according to Item 1, wherein the pigment dispersion paste comprises, per 100 parts by mass of the solids of the pigment-dispersing resin, 0.1 to 1,000 parts by mass of the pigment component, 0.1 to 25 parts by mass of the cellulose (A), and 0.1 to 5 parts by mass of the hydroxyalkyl imidazoline compound (B) represented by Formula (1), and 0.1 to 5 parts by mass of the compound (C) represented by Formula (2); and wherein the pigment dispersion paste, when adjusted to a solids concentration of 40 mass %, has an TI value of 1.8 to 4.0 as measured by the pigment test method of JIS K 5101-6-2.

Item 5. The pigment dispersion paste according to Item 1, wherein the cellulose (A) is a fine cellulose dispersion having a mean particle diameter of 0.01 to 6 μm.

Item 6. The pigment dispersion paste according to Item 1, wherein the cellulose (A) is a cellulose composite dispersion (a) comprising a fine cellulose dispersion and a water-soluble gum and/or a hydrophilic substance.

Item 7. The pigment dispersion paste according to any one of Items 1 to 6, wherein, after storage at 40° C. for 4 weeks, the pigment dispersion paste, when adjusted to a solids concentration of 40 mass %, has an TI value of 1.8 to 4.0 as measured by the pigment test method of JIS K 5101-6-2.

Item 8. The pigment dispersion paste according to any one of Items 1 to 7, wherein the increase in the TI value of the pigment dispersion paste after storage at 40° C. for 4 weeks is 0.5 or less as compared with the TI value of the pigment dispersion paste before storage; and wherein the TI values before and after storage at 40° C. for 4 weeks are both within the range of 1.8 to 4.0.

Item 9. The pigment dispersion paste according to any one of Items 1 to 8, which has a solids content of 40 to 60 mass %.

Item 10. The pigment dispersion paste according to any one of Items 1 to 9, wherein particles present in the pigment dispersion paste have a mean particle diameter of 1 to 3,000 nm.

Item 11. An electrodeposition coating composition comprising a base resin, a curing agent, and the pigment dispersion paste according to any one of Items 1 to 10 in an amount of 0.1 to 50 parts by mass on a solids basis per 100 parts by mass of the total solids content of the base resin and the curing agent.

### Effects of the Invention

Since the pigment dispersion paste for electrodeposition coating compositions according to the present invention has excellent storage stability, it can reduce the labor and cost of stirring during storage. Even if the pigment dispersion paste is stored in a tank or a drum without being stirred, a coated article with excellent finish can be provided because of good pigment re-dispersibility of the pigment dispersion paste.

The electrodeposition coating composition of the present invention exhibits excellent re-dispersibility when stirring and circulation of the coating composition in a coating line is stopped for a long time during holidays or nights and then restarted. This enables energy-saving operation and reduction in the amount of equipment, by suspending the operation of the pumps used for stirring, or reducing the number of such pumps.

### BEST MODE FOR CARRYING OUT THE INVENTION

The pigment dispersion paste for electrodeposition coating compositions and electrodeposition coating composition according to the present invention are described below in detail.

### Pigment Dispersion Paste and Electrodeposition Coating Composition

The present invention provides a pigment dispersion paste comprising (i) a pigment-dispersing resin, (ii) a pigment component, (iii) a cellulose (A), (iv) a hydroxyalkyl imidazoline compound (B) and/or a compound (C), and (v) water;

the pigment dispersion paste comprising, per 100 parts by mass of the solids of the pigment-dispersing resin, 0.1 to 1,000 parts by mass of the pigment component, 0.1 to 25 parts by mass of the cellulose (A), 0.1 to 5 parts by mass of the hydroxyalkyl imidazoline compound (B) represented by Formula (1) and/or the compound (C) represented by Formula (2); and

the pigment dispersion paste, when adjusted to a solids concentration of 40 mass %, having an TI value of 1.8 to 4.0 as measured by the pigment test method of JIS K 5101-6-2.

Further, the electrodeposition coating composition containing the pigment dispersion paste has the properties described in the Effects of the Invention. A detailed description is given below.

### (i) Pigment-Dispersing Resin:

Examples of the pigment-dispersing resin include tertiary amine-type epoxy resins, quaternary salt-type epoxy resins, and quaternary salt-type acrylic resins. Specifically, quaternary ammonium salt-type epoxy resins, tertiary sulfonium group-containing epoxy resins, tertiary amino group-containing epoxy resins, etc. are preferable.

### (ii) Pigment Component:

Usable pigment components include, but are not limited to, coloring pigments such as carbon black, perylene black, titanium oxide, phthalocyanine blue, phthalocyanine green, ochre, etc. Carbon black and perylene black are preferable for forming black-color coating films, as for parts and the like. Examples of usable extender pigments include clay, mica, talc, baryta, silica, etc. Examples of usable rust preventive pigments include aluminium phosphomolybdate, aluminium tripolyphosphate, etc. Other usable examples include bismuth oxide, bismuth hydroxide, basic bismuth carbonate, bismuth nitrate, bismuth silicate, hydrotalcite, zinc compounds, etc. The amount of pigment component is 0.1 to 1,000 parts by mass, preferably 10 to 800 parts by mass, and more preferably 50 to 600 parts by mass, per 100 parts by mass of the solids of the pigment-dispersing resin.

(iii) Cellulose (A):

For preparing the cellulose (A) used in the present invention, a cellulose obtained from materials such as wood pulp, purified linters, etc., is depolymerized by acid hydrolysis, alkaline oxidative degradation, enzymolysis, steam explosion degradation, etc., to obtain a cellulose with an average degree of polymerization of 30 to 375. The cellulose is then ground by, for example, wet milling under mechanical shear force to obtain a fine cellulose dispersion with a mean particle diameter of 0.01 to 6 μm, which can be used as the cellulose (A).

The wet milling can be carried out using a media mill, such as a wet vibration mill, wet planetary vibration mill, wet ball mill, wet roll mill, wet ball mill, wet beads mill, or wet paint shaker; a high-pressure homogenizer; or the like. Of high-pressure homogenizers, those in which two portions of slurry are led to fine orifices at a high pressure of about 500 kg/cm² or more and collided with each other at a high flow rate, are effective.

The optimum milling concentration in these mills varies depending on the type of mill, but generally a preferable solids concentration is 5 to 15% in media mills, and 5 to 20% in high pressure homogenizers. Media mills are suitable for efficiently milling the cellulose. Such milling can yield a fine cellulose with a mean particle diameter (Note 1) of 0.01 to 6 μm, preferably 0.1 to 3 μm, and more preferably 0.2 to 1 μm or smaller.

(Note 1) As used herein, the mean particle diameter is measured by a dynamic light-scattering method/laser Doppler method (UPA method). Specifically, the mean particle diameter can be measured using UPA-EX250 (a trade name of a particle size distribution measurement apparatus produced by Nikkiso Co., Ltd.).

It is also possible to use as the cellulose (A), a cellulose composite dispersion (a) obtained by mixing the fine cellulose dispersion with a water-soluble gum and/or a hydrophilic substance. This can prevent re-agglomeration of fine cellulose particles at the time of drying, and can further improve the stability of the pigment dispersion paste.

Examples of the cellulose composite dispersion (a) include a cellulose composite (a1) comprising a fine cellulose, a water-soluble gum, and a hydrophilic substance; a cellulose composite (a2) comprising a fine cellulose and a water-soluble gum; and a cellulose composite (a3) comprising a fine cellulose and a hydrophilic substance.

The cellulose composite dispersion (a) can be produced by adding and dispersing a water-soluble gum and/or a hydrophilic substance into a fine cellulose dispersion obtained by milling a cellulose, to thereby form a homogeneous slurry, and drying the slurry.

Of water-soluble gums, those having high water-swelling properties and good compatibility with celluloses in water are preferable. Usable examples include locust bean gum, guar gum, tamarind gum, quince seed gum, karaya gum, gum arabic, gum tragacanth, ghatti gum, arabinogalactan, agar, carageenan, alginic acid and salts thereof, furcellaran, pectin, quince, xanthan gum, curdlan, pullulan, dextran, gellan gum, gelatin, cellulose sodium glycolate, and like cellulose derivatives. Of these, cellulose sodium glycolate has both swelling properties and hydrophilicity, and thus can be used as a gum singly without combining with a hydrophilic substance.

Examples of hydrophilic substances include water, starch hydrolysates, dextrins, glucose, fructose, xylose, sucrose, lactose, maltose, isomerized sugars, coupling sugars, paratinose, neosugar, mannitol, saccharified reduced starch, lactulose, polydextrose, fructooligosaccharide, galactooligosaccharide, and like water-soluble saccharides including monosaccharides and oligosaccharides; xylitol, maltitol, mannite, sorbitol and like sugar alcohols; sorbose; etc. Hydrophilic substances promote dispersion of the fine cellulose in water, and, when used in combination with a water-soluble gum, exhibit remarkable effects in easy dispersibility and dispersion stability.

In view of the stability of the coating composition, the proportion of fine cellulose dispersion in the cellulose composite dispersion (a) is generally 0.1 to 99 mass %, preferably 1 to 95 mass %, and more preferably 10 to 85 mass %, based on the solids content of cellulose composite dispersion (a). When a water-soluble gum and hydrophilic substance are used in combination, the mass ratio of water-soluble gum/hydrophilic substance may be usually 95/5 to 5/95, and preferably 80/20 to 20/80.

The cellulose composite dispersion (a) can be produced by mixing and dispersing the fine cellulose dispersion in the water-soluble gum and/or hydrophilic substance and drying the mixture. In the production, it is important for the water-soluble gum to be thoroughly dissolved and homogenously mixed. Heating may be carried out to promote dissolution and formation of the composite.

The cellulose (A) thus obtained can be dried by, for example, lyophilization, spray drying, or the like, but drying the cellulose (A) in the form of a film is an advantageous method. The method of drying the cellulose in the form of a film is performed by, for example, applying a slurry of a fine cellulose dispersion obtained by milling a cellulose, or a slurry obtained by uniformly admixing a water-soluble gum and/or a hydrophilic substance with such a fine cellulose dispersion, on a substrate such as glass, stainless steel, aluminium, nickel/chromium-plated steel sheets, or the like, and drying the slurry.

The substrate may be pre-heated, or may be heated after application of the slurry using infrared rays, hot blast, high-frequency waves, or the like. It is preferable that the drying temperature be no higher than 200° C., and the applied coating thickness be no more than 10 mm as the thickness of slurry. In industrial operation, a dryer such as a steel belt dryer, a drum dryer, a disk dryer, or the like can be used to obtain a dry powder. Electron microscopy of the dry powder thus obtained shows that a network of fine particles of the cellulose dispersion is disposed on the surface, and innumerable voids are observed among the fine particles of the cellulose dispersion.

Examples of commercial products of the cellulose (A) include Avicel RC-N81, Avicel RC-N30, Avicel RC-591, Avicel CL-611, and Ceolus Cream FP-03 (trade names, products of Asahi Kasei Chemicals, Corp.), and the like.

(iv-1) Hydroxyalkyl Imidazoline Compound (B)

The pigment dispersion paste for electrodeposition coating compositions according to the present invention may contain, if necessary, a hydroxyalkyl imidazoline compound (B) represented by Formula (1).

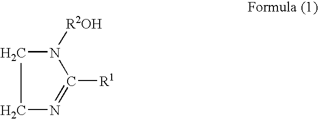

wherein R¹ is a C₆₋₃₂ hydrocarbon group and R² is a C₂₋₆ alkylene group.

The hydroxyalkyl imidazoline compound (B) represented by Formula (1) is an imidazoline compound having as R¹ a hydrocarbon group having 6 to 32 carbon atoms, preferably 10 to 25 carbon atoms, and more preferably 15 to 19 carbon atoms; and a hydroxyalkyl group represented by R²OH having 2 to 6 carbon atoms, preferably 2 to 4 carbon atoms, and more preferably 2 to 3 carbon atoms.

Examples of the hydrocarbon group represented by R¹ in Formula (1) include straight- or branched-chain hydrocarbon groups having 6 to 32, preferably 10 to 25, and more preferably 15 to 19 carbon atoms (e.g., alkyl groups, alkenyl groups, and alkynyl groups), such as undecyl groups, tridecyl groups, pentadecyl groups, heptadecyl groups, 8-heptadecen-1-yl groups, 8,11-heptadecadien-1-yne groups, etc.

Specifically, in the production of the hydroxyalkyl imidazoline compound (B), fatty acids can be used, including tall oil fatty acid, sunflower oil fatty acid, palm oil fatty acid, peanut oil fatty acid, soybean oil fatty acid, coconut oil fatty acid, cotton oil fatty acid, linseed oil fatty acid, sesame oil fatty acid, safflower oil fatty acid, olive oil fatty acid, dehydrated castor oil fatty acid, etc.

R² in the hydroxyalkyl group is a C₂₋₆ alkylene group, such as an ethylene residue, a 1,3-propylene residue, a 1,2-propylene residue, a 1,4-butylene residue, a 1,2-butylene residue, 1,6-hexylene residue, or the like. Of such examples of the hydroxyalkyl imidazoline compound (B), 2-alkyl-1-hydroxyethyl-2-imidazoline is preferable from the viewpoint of re-dispersibility and coating composition stability.

(iv-2) Compound (C)

The pigment dispersion paste of the present invention may contain, if necessary, a compound (C) represented by Formula (2). The compound (C) is useful as a nonionic surfactant.

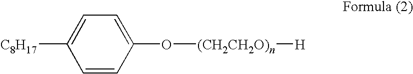

wherein n is an integer from 11 to 16.

In the compound (C) useful in the pigment dispersion paste of the present invention, the number n of the repeating units —(CH₂CH₂O)— in Formula (2) is 11 to 16, preferably 13 to 15, and more preferably 14.

The cellulose (A), hydroxyalkyl imidazoline compound (B), and/or compound (C) are introduced into an electrodeposition coating composition in the same manner as the addition of a pigment to an electrodeposition coating composition.

From the viewpoint of the re-dispersibility of the pigment dispersion paste and finish, it is desirable that the amounts of the cellulose (A), hydroxyalkyl imidazoline compound (B), and compound (C) be, per 100 parts by mass of the solids of the pigment-dispersing resin, 0.1 to 25 parts by mass, preferably 0.15 to 10 parts by mass, and more preferably 0.2 to 5 parts by mass of the cellulose (A);

0.1 to 5 parts by mass, preferably 0.2 to 3 parts by mass, and more preferably 0.3 to 2 parts by mass of the optionally used hydroxyalkyl imidazoline compound (B); and

0.1 to 5 parts by mass, preferably 0.2 to 3 parts by mass, and more preferably 0.3 to 2 parts by mass of the optionally used compound (C).

It is preferable for the pigment dispersion paste of the present invention to contain the pigment-dispersing resin, pigment component, cellulose (A), and hydroxyalkyl imidazoline compound (B) and/or compound (C) in specific proportions, and to have an TI value (Note 2) of 1.8 to 4.0, preferably 2.0 to 3.8, and more preferably 2.5 to 3.5, when the pigment dispersion paste has a solids concentration of 40 mass %.

Further, considering severe conditions as in summer, it is desirable that, after the pigment dispersion paste is adjusted to a solids concentration of 40 mass % and stored at 40° C. for 4 weeks, the pigment dispersion paste has an TI value of 1.8 to 4.0, preferably 2.0 to 3.8, and more preferably 2.0 to 3.5.

(Note 2) The “TI value (thixotropic index)” as used herein is the value described in JIS K 5101-6-2 (2004), Pigment Test Method, Section 2, Rotational Viscometer Method, and can be determined by measuring the viscosity (mPa·s) using a Brookfield viscometer (e.g., an “RE-80U viscometer” produced by Toki Sangyo Co., Ltd.) at 20° C. and 6 rpm and 60 rpm, and calculating the “viscosity measured at 6 rpm/viscosity measured at 60 rpm”. The TI value may be measured at any time from immediately after the preparation of the pigment dispersion paste until the time of use. Such measured values within the range of 1.8 to 4.0 satisfy the requirements for the pigment dispersion paste of the present invention.

When the pigment dispersion paste has an TI value of more than 4.0, the pigment is likely to agglomerate. Thus, an electrodeposition coating composition obtained using such a pigment dispersion paste may block a filter. Further, the resulting electrodeposition coating composition may have seeding or unevenness, which deteriorates the finish.

When the pigment dispersion paste has an TI value of less than 1.8, the pigment is liable to settle and form a hard cake layer, and therefore re-dispersion is likely to be difficult. Thus, an electrodeposition coating composition obtained using such a pigment dispersion paste may block a filter. Further, the resulting electrodeposition coating composition may have seeding or unevenness, which deteriorates the finish.

Accordingly, in a coating line using an electrodeposition coating composition comprising the pigment dispersion paste of the present invention, even if the circulation of the coating composition is stopped during holidays or nights for a long period and then restarted when the coating line is operated, the coating composition does not block a filter because of its excellent re-dispersibility, and provides a coating film with excellent finish.

The pigment dispersion paste of the present invention can be prepared by mixing the pigment-dispersing resin, pigment component, cellulose (A), hydroxyalkyl imidazoline compound (B) and/or compound (C), water, and if necessary, a curing catalyst, neutralizer, etc., and dispersing the pigment.

The curing catalyst is effective for promoting the cross-linking reaction of the coating film. Usable examples include dioctyltin oxide, dibutyltin oxide, tin octoate, dibutyltin dilaurate, dibutyltin dibenzoate, etc. Examples of the neutralizer include carboxylic acids such as acetic acid, formic acid, lactic acid, etc.

The pigment dispersion paste with excellent re-dispersibility can be obtained by treatment with dispersion means such as a ball mill, a pebble mill, a sand mill, a planetary ball mill, a homogenizer, or the like, for about 0.5 to about 96 hours, preferably about 1 to about 48 hours, and more preferably about 5 to about 24 hours, until the solid particles (containing the pigment and cellulose) in the pigment dispersion paste have a mean particle diameter of 1 to 3,000 nm, preferably 1 to 1,000 nm, and more preferably 300 to 700 nm.

The obtained pigment dispersion paste exhibits excellent re-dispersibility even after long-term storage in a container or a drum without stirring, thereby facilitating long-term storage and long-distance transportation. The pigment dispersion paste can be mixed with an emulsion in which a base resin, a curing agent, etc. are dispersed, to produce an electrodeposition coating composition. The electrodeposition coating composition is described below.

### Electrodeposition Coating Composition:

The electrodeposition coating composition comprising the pigment dispersion paste of the present invention may be anionic or cationic, but is preferably cationic from the viewpoint of corrosion resistance. The base resin may be any of epoxy resins, acrylic resins, polybutadiene resins, alkyd resins, and polyester resins, among which amine-added epoxy resins are preferable from the viewpoint of corrosion resistance.

Particularly preferable epoxy resins for use as starting materials of the base resin are those obtained by reacting a polyphenol compound with an epihalohydrin, such as epichlorohydrin, from the viewpoint of the corrosion resistance of the coating film.

The base resin is a resin having in its molecule a cationizable group, such as an amino group, an ammonium salt group, a sulfonium salt group, a phosphonium salt group, or the like. Examples of types of the base resin include those conventionally used, such as epoxy resins, acrylic resins, polybutadiene resins, alkyd resins, polyester resins, etc. In particular, amine-added epoxy resins obtained by an addition reaction of an amino group-containing compound to an epoxy resin are preferable for achieving both corrosion resistance and electrodeposition coating applicability onto hot-dip alloy-plated steel sheets.

Examples of such amine-added epoxy resins include (1) an adduct of an epoxy resin with a primary mono- or polyamine, a secondary mono- or polyamine, or a primary/secondary mixed polyamine (e.g., U.S. Pat. No. 3,984,299, specification); (2) an adduct of an epoxy resin with a secondary mono- or polyamine having a ketiminized primary amino group (e.g., U.S. Pat. No. 4,017,438, specification); (3) a reaction product obtained by etherification of an epoxy resin with a hydroxy compound having a ketiminized primary amino group (e.g., Japanese Unexamined Patent Publication No. 1984-43013); etc.

These prior art documents are incorporated into the present specification by reference in their entirety.

Suitable epoxy resins for use in the production of the above amine-added epoxy resins include compounds having at least one, and preferably two epoxy groups per molecule; a number average molecular weight of generally at least 300, preferably 400 to 4,000, and more preferably 800 to 2,500; and an epoxy equivalent of at least 160, preferably 180 to 2,500, and more preferably 400 to 1,500. In particular, compounds obtained by reacting a polyphenol compound with an epihalohydrin are preferable.

The number average molecular weight is determined according to the method of JIS K 0124-83, from a calibration curve of polystyrene standards and a chromatogram obtained with an RI refractometer at 40° C. and a flow rate of 1.0 ml/min, using four separation columns “TSK GEL4000HXL”, “TSK GEL3000HXL”, “TSK GEL2500HXL”, and “TSK GEL2000HXL” (produced by Tosoh Corp.) and tetrahydrofuran for GPC as an eluant.

Examples of polyphenol compounds used for forming such epoxy resins include bis(4-hydroxyphenyl)-2,2-propane (bisphenol A), bis(4-hydroxyphenyl)methane (bisphenol F), bis(4-hydroxycyclohexyl)methane (hydrogenated bisphenol F), 2,2-bis(4-hydroxycyclohexyl)propane (hydrogenated bisphenol A), 4,4′-dihydroxybenzophenone, bis(4-hydroxyphenyl)-1,1-ethane, bis(4-hydroxyphenyl)-1,1-isobutane, bis(4-hydroxy-3-tert-butyl-phenyl)-2,2-propane, bis(2-hydroxynaphthyl)methane, tetra(4-hydroxyphenyl)-1,1,2,2-ethane, 4,4′-dihydroxydiphenylsulfone, phenol novolac, cresol novolac, etc.

Of epoxy resins obtained by reacting a polyphenol compound with epichlorohydrin, those of the following formula derived from bisphenol A is preferable.

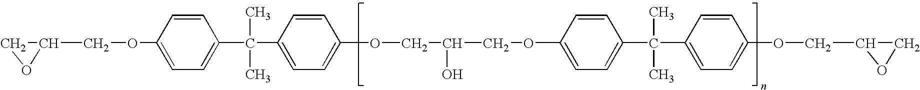

wherein n is preferably 0 to 8.

Examples of commercial products of such epoxy resins include those available from Japan Epoxy Resins Co., Ltd. under the trade names of jER828EL, jER1002, jER1004, and jER1007.

Such epoxy resins may be those partially reacted with a polyol, a polyether polyol, a polyester polyol, a polyamideamine, a polycarboxylic acid, a polyisocyanate compound, or the like; and may be those graft-polymerized with a lactone such as 6-caprolactone or the like, an acrylic monomer, or the like.

Examples of primary mono- and polyamines, secondary mono- and polyamines, and primary/secondary mixed polyamines for use in the production of the amine-added epoxy resin (1) above include mono- or dialkylamines such as monomethylamine, dimethylamine, monoethylamine, diethylamine, monoisopropylamine, diisopropylamine, monobutylamine, dibutylamine, etc.; alkanolamines such as monoethanolamine, diethanolamine, mono(2-hydroxypropyl)amine, monomethylaminoethanol, etc.; alkylene polyamines such as ethylenediamine, propylenediamine, butylenediamine, hexamethylenediamine, diethylenetriamine, triethylenetetramine, etc.; and the like.

Examples of secondary mono- and polyamines having a ketiminized primary amino group for use in the production of the amine-added epoxy resin (2) above include ketimines formed by reacting a ketone compound with, for example, diethylene triamine or like primary/secondary mixed polyamine for use in the production of the amine-added epoxy resin (1).

Examples of hydroxy compounds having a ketiminized primary amino group for use in the production of the amine-added epoxy resin (3) above include hydroxy-containing ketimines obtained by reacting a ketone compound with, for example, monoethanol amine, mono(2-hydroxypropyl)amine or like compounds having a primary amino group and hydroxy group, among primary mono- and polyamines, secondary mono- and polyamines, and primary/secondary mixed polyamines for use in the production of the amine-added epoxy resin (1).

In order to achieve the effects of the present invention, it is particularly preferable to use as a base resin a xylene resin-modified amine-added epoxy resin obtained by reacting an epoxy resin having an epoxy equivalent of 180 to 2,500, and preferably 250 to 2,000, with a xylene formaldehyde resin having a phenolic hydroxy group and an amino group-containing compound; the amino group-containing compound being used in a proportion of 5 to 25 mass % based on the total solids mass of the epoxy resin, xylene formaldehyde resin, and amino group-containing compound.

Epoxy resins as mentioned above can be used as starting materials for the production of the amino group-containing epoxy resin. The xylene formaldehyde resin is useful for the internal plasticization (modification) of the epoxy resin, and can be produced, for example, by condensation reaction of xylene and a formaldehyde with a phenol in the presence of an acid catalyst.

Examples of the formaldehyde include industrially widely available formalin, paraformaldehyde, etc. Such a formaldehyde may be added directly, or a compound that generates a formaldehyde such as trioxane or the like may be added to synthesize the above resin.

The above-mentioned phenol encompasses mono- or divalent phenolic compounds having two or three reactive sites. Specific examples include phenol, cresol, para-octylphenol, nonylphenol, bisphenol propane, bisphenol methane, resorcinol, pyrocatechol, hydroquinone, para-tert-butylphenol, bisphenol sulfone, bisphenol ether, para-phenylphenol, etc. These may be used singly or in a combination of two or more. Among these, phenol and cresol are particularly preferable.

Examples of the acid catalyst used for the condensation reaction of xylene and a formaldehyde with a phenol include sulfuric acid, hydrochloric acid, paratoluene sulfonic acid, oxalic acid, etc., among which sulfuric acid is particularly preferable.

The condensation reaction can be performed, for example, by heating xylene, phenols, water, formalin, etc. in the reaction system to a temperature at which they are refluxed, i.e., usually at about 80 to about 100° C. The reaction can be usually terminated in about 2 to 6 hours.

The xylene-formaldehyde resin can be obtained by heating and reacting xylene, a formaldehyde, and optionally a phenol in the presence of an acid catalyst under the above-mentioned conditions.

The xylene-formaldehyde resin thus obtained can generally have a viscosity of 20 to 50,000 mPa·s (25° C.), preferably 25 to 30,000 mPa·s, and more preferably 30 to 15,000 mPa·s (25° C.); and preferably has a hydroxy equivalent of generally 100 to 50,000, preferably 150 to 30,000, and more preferably 200 to 10,000.

The amino group-containing compound is a cationic group-introducing group for introducing an amino group to the epoxy resin to cationize the epoxy resin, and amino group-containing compounds for use in the production of the cationic resin described above may be used.

The reactions of the above xylene formaldehyde resin and amino group-containing compound with the epoxy resin may be carried out in any order. It is generally preferable to simultaneously subject the xylene formaldehyde resin and amino group-containing compound to an addition reaction with the epoxy resin.

The addition reaction is usually carried out in a suitable solvent at 80 to 170° C., and preferably 90 to 150° C. for about 1 to about 6 hours, and more preferably about 1 to about 5 hours. Examples of the solvent include hydrocarbon solvents such as toluene, xylene, cyclohexane, n-hexane, etc.; ester solvents such as methyl acetate, ethyl acetate, butyl acetate, etc.; ketone solvents such as acetone, methyl ethyl ketone, methyl isobutyl ketone, methyl amyl ketone, etc.; amide solvents such as dimethylformamide, dimethylacetamide, etc.; alcohol solvents such as methanol, ethanol, n-propanol, iso-propanol, etc.; mixtures thereof; etc.

The proportions of the reactants in the addition reaction are not strictly limited and can be varied, but it is suitable that the proportions be within the following ranges based on the total solids mass of the three reactants, i.e., epoxy resin, xylene-formaldehyde resin, and amino group-containing compound:

generally 50 to 90 mass %, and preferably 50 to 85 mass % of the epoxy resin; generally 5 to 45 mass %, and preferably 6 to 43 mass % of the xylene-formaldehyde resin; and generally 5 to 25 mass %, and preferably 6 to 20 mass % of the amino group-containing compound.

As a curing agent for cationic electrodeposition coating compositions, heretofore known curing agents are usable, including blocked polyisocyanate compounds, amino resins, etc., among which blocked polyisocyanate compounds are particularly preferable.

Known polyisocyanate compounds can be used for blocked polyisocyanate compounds. Usable examples include aromatic, aliphatic, and alicyclic polyisocyanates such as tolylene diisocyanate, xylylene diisocyanate, phenylene diisocyanate, diphenylmethane-2,2′-diisocyanate, diphenylmethane-2,4′-diisocyanate, diphenylmethane-4,4′-diisocyanate, crude MDI (“polymethylene polyphenyl isocyanate”), bis(isocyanatemethyl) cyclohexane, tetramethylene diisocyanate, hexamethylene diisocyanate, methylene diisocyanate, isophorone diisocyanate, etc.; cyclopolymers and biurets of these polyisocyanate compounds; and combinations thereof.

Aromatic polyisocyanate compounds, such as tolylene diisocyanate, xylylene diisocyanate, phenylene diisocyanate, diphenylmethane-2,4,-diisocyanate, diphenylmethane-4,4′-diisocyanate, crude MDI, etc., are particularly preferable from the viewpoint of corrosion resistance.

Examples of such polyisocyanate compounds include aromatic, aliphatic and alicyclic polyisocyanate compounds such as tolylene diisocyanate, xylylene diisocyanate, phenylene diisocyanate, bis(isocyanatemethyl)cyclohexane, tetramethylene diisocyanate, hexamethylene diisocyanate, methylene diisocyanate, isophorone diisocyanate, etc.; and terminal isocyanate-containing compounds obtained by reacting an excess amount of such an isocyanate compound with a low-molecular-weight active hydrogen-containing compound such as ethylene glycol, propylene glycol, trimethylolpropane, hexanetriol, castor oil, or the like.

Examples of blocking agents include lactam compounds such as ε-caprolactam, γ-butyrolactam, etc.; oxime compounds such as methyl ethyl ketoxime, cyclohexanone oxime, etc.; phenol compounds such as phenol, para-t-butylphenol, cresol, etc.; aliphatic alcohols such as n-butanol, 2-ethylhexanol, etc.; aromatic alkyl alcohols such as phenylcarbinol, methylphenylcarbinol, etc.; ether alcohol compounds such as ethylene glycol monobutyl ether and the like; etc. Among these, oxime and lactam blocking compounds dissociate at a relatively low temperature, and therefore are especially preferable from the viewpoint of low-temperature curability. The base resin can be dissolved or dispersed in water by neutralizing the resin with a water-soluble organic acid such as formic acid, acetic acid, lactic acid, or the like, thereby forming an emulsion.

For preparation of a cationic electrodeposition coating composition, the pigment dispersion paste is mixed with the emulsion; additives such as an organic solvent, surfactant, surface control agent, cissing inhibitor, etc., are added as required, and the resulting mixture is diluted with deionized water or the like so as to be 1 to 40% by weight, preferably 10 to 30% by weight of the solid content, and the pH is adjusted to 5.0 to 7.0, to thereby obtain a cationic electrodeposition coating composition bath.

Electrodeposition coating is usually performed at a bath temperature of 15 to 35° C. and a voltage of 100 to 400 V. The thickness of the electrodeposition coating film is not limited, but is preferably 10 to 40 μm on a cured film basis. It is generally suitable that the baking/curing be performed at 100 to 200° C. for 5 to 90 minutes.

To obtain the effects of the present invention, it is necessary for the pigment dispersion paste to (1) contain a cellulose (A) and a hydroxyalkyl imidazoline compound (B) and/or a compound (C), and (2) have an TI value within a predetermined range; and preferably, (3) the particles in the pigment dispersion paste have a mean particle diameter of 1 to 3,000 nm.

The electrodeposition coating composition comprising the pigment dispersion paste exhibits excellent re-dispersibility and excellent stability, when stirring and circulation of the coating composition in a coating line are stopped during holidays or nights for a long period and then restarted, thereby enabling energy-saving operation.

The coating composition forms a cured coating film having excellent corrosion resistance, excellent electrodeposition coating applicability to steel sheets for rust prevention, and excellent adhesion to substrates; and is useful as an undercoating composition for, for example, automobile bodies, automobile parts, industrial applications, etc.

### EXAMPLES

The following Examples are intended to illustrate the present invention in further detail, and in no way to limit the scope of the invention. In the Examples, parts and percentages are by mass.

### Production Example 1

### Production of Cellulose Dispersion No. 1

Commercially available pulp (DP pulp) was finely ground and dissolved in 65 mass % sulfuric acid at −5° C. so that the pulp content became 4 mass %. The cellulose solution in sulfuric acid was poured into water under vigorous stirring at a mass ratio of the cellulose solution to water of 1:2.7, to precipitate the cellulose. The resulting flaky cellulose dispersion was hydrolyzed at 80° C. for 40 minutes, filtered, and washed with water to obtain an aqueous cellulose dispersion in slurry form. Subsequently, the aqueous dispersion was diluted with ion exchange water to a cellulose concentration of 4.0 mass %, treated with an ultra-high pressure homogenizer at an operation pressure of 175 MPa, heated at 80° C. for 60 minutes, and then spray-dried to obtain cellulose dispersion No. 1. Cellulose dispersion No. 1 had a mean particle diameter of 0.24 mm.

### Production Example 2

### Production of Cellulose Dispersion No. 2

Commercially available pulp (DP pulp) was finely ground and hydrolyzed at 105° C. for 20 minutes in 10% hydrochloric acid. The resulting acid-insoluble residue was filtered and washed to obtain a cellulose dispersion with a solids content of 10%.

The cellulose dispersion was ground by passing twice through a wet grinding media mill (Apex Mill AM-1, produced by Kotobuki Industries, Co., Ltd.) using zirconia beads with a diameter of 1 mm as the media at a stirring blade rotation speed of 1,800 rpm and a cellulose dispersion supply rate of 0.4 L/min, to obtain a cellulose in paste form. The cellulose dispersion had a mean particle diameter of 3.1 μm.

Subsequently, a dispersion with a total solids concentration of 3.5% containing a cellulose, xanthan gum, and glucose at a solids ratio of 75/5/20 was prepared. The dispersion was heated at 80° C. for 60 minutes with stirring and spray-dried to obtain cellulose dispersion No. 2.

### Production Example 3

### Production of Pigment Dispersion Paste No. 1

In a ball mill, 8.33 parts (solids: 5 parts) of 60% epoxy-based quaternary ammonium salt-type pigment-dispersing resin, 0.25 parts (solids: 0.25 parts) of cellulose dispersion No. 1 obtained in Production Example 1, 1.0 parts (solids: 0.25 parts) of Hartall M33 (Note 5), 7 parts of clay, 3 parts of carbon black, 1 part of bismuth hydroxide, 1 part of dioctyl tin oxide, and 22 parts of deionized water were mixed while adjusting the dispersion period in the ball mill to obtain a pigment dispersion paste No. 1 with a solids content of 40%. Pigment dispersion paste No. 1 had a mean particle diameter of 2,000 nm.

### Production Example 4

### Production of Pigment Dispersion Paste No. 2

Pigment dispersion paste No. 2 with the formulation shown in Table 1 was obtained in the same manner as the production of pigment dispersion paste No. 1 in Production Example 3. Pigment dispersion paste No. 2 had a mean particle diameter of 1,500 nm.

### Production Example 5

### Production of Pigment Dispersion Paste No. 3

In a ball mill, 8.33 parts (solids: 5 parts) of 60% epoxy-based quaternary ammonium salt-type pigment-dispersing resin, 0.25 parts (solids: 0.25 parts) of cellulose dispersion No. 2 obtained in Production Example 2, 1.0 parts (solids: 0.25 parts) of Hartall M33 (Note 5), 7 parts of clay, 3 parts of carbon black, 1 part of bismuth hydroxide, 1 part of dioctyl tin oxide, and 22.0 parts of deionized water were mixed while adjusting the dispersion period in the ball mill to obtain pigment dispersion paste No. 3 with a solids content of 40%. Pigment dispersion paste No. 3 had a mean particle diameter of 2,800 nm.

### Production Examples 6 to 11

### Production of Pigment Dispersion Pastes No. 4 to No. 9

Pigment dispersion pastes No. 4 to No. 9 with the formulations shown in Table 1 were obtained in the same manner as the production of pigment dispersion paste No. 3 in Production Example 5. The mean particle diameter of pigment dispersion pastes No. 4 to No. 9 is shown in Table 3.

TABLE 1

| | Prod. | Prod. | Prod. | Prod. | Prod. | Prod. | Prod. | Prod. | Prod. |
|---|---|---|---|---|---|---|---|---|---|
| | Ex. 3 | Ex. 4 | Ex. 5 | Ex. 6 | Ex. 7 | Ex. 8 | Ex. 9 | Ex. 10 | Ex. 11 |
| Pigment dispersion paste | No. 1 | No. 2 | No. 3 | No. 4 | No. 5 | No. 6 | No. 7 | No. 8 | No. 9 |
| 60% Pigment dispersing | 8.33 | 8.33 | 8.33 | 8.33 | 8.33 | 8.33 | 8.33 | 8.33 | 8.33 |
| resin | | | | | | | | | |
| (solids) | (5) | (5) | (5) | (5) | (5) | (5) | (5) | (5) | (5) |
| Cellulose dispersion | 0.25 | 0.25 | | | | | | | |
| No. 1 | (0.25) | (0.25) | | | | | | | |
| Cellulose dispersion | | | 0.25 | | | | 0.25 | 0.25 | 0.25 |
| No. 2 | | | (0.25) | | | | (0.25) | (0.25) | (0.25) |
| Avicel RC-N81 (Note 3) | | | | 0.25 | | | | | |
| | | | | (0.25) | | | | | |
| Avicel RC-N30 (Note 4) | | | | | 0.25 | 0.5 | | | |
| | | | | | (0.25) | (0.5) | | | |
| Hartall M33 (Note 5) | 1.0 | | 1.0 | 1.0 | 1.0 | 1.0 | | 1.0 | 2.0 |
| Solids content: 20% | (0.2) | | (0.2) | (0.2) | (0.2) | (0.2) | | (0.2) | (0.4) |
| Surfactant No. 1 (Note 6) | | 0.6 | | | | | 0.6 | 0.6 | 1.3 |
| Solids content: 80% | | (0.5) | | | | | (0.5) | (0.5) | (1.0) |
| Clay | 7 | 7 | 7 | 7 | 7 | 7 | 7 | 7 | 7 |
| Carbon black | 3 | 3 | 3 | 3 | 3 | 3 | 3 | 3 | 3 |
| Bismuth hydroxide | 1 | 1 | 1 | 1 | 1 | 1 | 1 | 1 | 1 |
| Dioctyl tin oxide | 1 | 1 | 1 | 1 | 1 | 1 | 1 | 1 | 1 |
| Deionized water | 22.2 | 23.3 | 22.2 | 22.2 | 22.2 | 22.5 | 23.3 | 22.8 | 23.0 |
| 40% Pigment dispersion | 43.8 | 44.5 | 43.8 | 43.8 | 43.8 | 44.3 | 44.5 | 45.0 | 46.8 |
| paste | | | | | | | | | |
| (solids) | (17.5) | (17.8) | (17.5) | (17.5) | (17.5) | (17.7) | (17.8) | (18.0) | (18.7) |

In the formulations, the numerals indicate parts by mass, and the parenthesized numerals indicate solids contents.
(Note 3): Avicel RC-N81 is a trade name of a cellulose dispersion (crystalline cellulose, karaya gum, dextrin) produced by Asahi Kasei Chemicals Corp.
(Note 4): Avicel RC-N30 is a trade name of a cellulose dispersion (crystalline cellulose, xanthan gum, dextrin) produced by Asahi Kasei Chemicals Corp.
(Note 5): Hartall M33 is a trade name of a compound of Formula (1) in which R¹ = C₁₇H₃₃ and R² = C₂H₄, produced by Harima Chemicals., Inc. and having a solids content of 20%.
(Note 6): Surfactant No. 1 is polyoxyethylene glycol octylphenyl ether (a compound of Formula (2) in which n = 14).

### Comparative Production Examples 1 to 6

### Production of Pigment Dispersion Pastes No. 10 to No. 15

Pigment dispersion pastes No. 10 to No. 15 with the formulations shown in Table 2 were obtained in the same manner as the production of pigment dispersion paste No. 1 in Production Example 3.

The mean particle diameter of pigment dispersion pastes No. 10 to No. 15 is shown in Table 4 given hereinafter.

TABLE 2

| | Comp. | Comp. | Comp. | Comp. | Comp. | Comp. |
|---|---|---|---|---|---|---|
| | Prod. | Prod. | Prod. | Prod. | Prod. | Prod. |
| | Ex. 1 | Ex. 2 | Ex. 3 | Ex. 4 | Ex. 5 | Ex. 6 |
| Pigment dispersion | No. 10 | No. 11 | No. 12 | No. 13 | No. 14 | No. 15 |
| paste | | | | | | |
| 60% Pigment | 8.33 | 8.33 | 8.33 | 8.33 | 8.33 | 8.33 |
| dispersing resin | | | | | | |
| (solids) | (5) | (5) | (5) | (5) | (5) | (5) |
| Cellulose | 0.25 | | | | | |
| dispersion No. 1 | (0.25) | | | | | |
| Cellulose | | 0.25 | 0.25 | 0.25 | 0.25 | 0.25 |
| dispersion No. 2 | | (0.25) | (0.25) | (0.25) | (0.25) | (0.25) |
| Avicel RC-N81 | | | | | | |
| (Note 3) | | | | | | |
| Avicel RC-N30 | | | | | | |
| (Note 4) | | | | | | |
| Hartall M33 | | | | | 2.0 | 2.0 |
| (Note 5) | | | | | (0.4) | (0.4) |
| Solids content: 20% | | | | | | |
| Surfactant No. 1 | | | | | 1.3 | 1.3 |
| (Note 6) | | | | | (1.0) | (1.0) |
| Solids content: 80% | | | | | | |
| Surfactant No. 2 (Note 7) | | 1.3 | | | | |
| Solids content: 80% | | (1.0) | | | | |
| Surfactant No. 3 (Note 8) | | | 1.3 | | | |
| Solids content: 80% | | | (1.0) | | | |
| Noigen EA80 (Note 9) | | | | 1.3 | | |
| Solids content: 80% | | | | (1.0) | | |
| Clay | 7 | 7 | 7 | 7 | 20 | 30 |
| Carbon black | 3 | 3 | 3 | 3 | 3 | 3 |
| Bismuth hydroxide | 1 | 1 | 1 | 1 | 1 | 1 |
| Dioctyl tin oxide | 1 | 1 | 1 | 1 | 1 | 1 |
| Deionized water | 22.7 | 24.0 | 24.0 | 24.0 | 42.5 | 57.5 |
| 40% Pigment | 43.3 | 45.8 | 45.8 | 45.8 | 79.3 | 104.3 |
| dispersion paste | | | | | | |
| (solids) | (17.3) | (18.3) | (18.3) | (18.3) | (31.7) | (41.7) |

In the formulations, the numerals indicate parts by mass, and the parenthesized numerals indicate solids contents.
(Note 7): Surfactant No. 2 is polyoxyethylene glycol octylphenyl ether (a compound of Formula (2) in which n = 16)
(Note 8): Surfactant No. 3 is polyoxyethylene glycol octylphenyl ether (a compound of Formula (2) in which n = 11)
(Note 9): Noigen EA80 is a trade name of polyoxyethylene glycol nonylphenyl ether (nonionic surfactant, (C₂H₄O) = 1) produced by Dai-Ichi Kogyo Seiyaku Co., Ltd.

### Example 1

The TI value (Note 10) of pigment dispersion paste No. 1 obtained in Production Example 3 was measured. Further, 100 g of each pigment dispersion was weighed out, placed in a glass container with a lid, and stored at 40° C. for 4 weeks. The conditions and TI value (Note 10) after storage were determined.

### Examples 2 to 9

Following the procedure of Example 1, pigment dispersion pastes No. 2 to No. 9 were stored, and the conditions and TI value after storage (Note 2) were determined.

TABLE 3

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Pigment dispersion paste | | No. 1 | No. 2 | No. 3 | No. 4 | No. 5 | No. 6 | No. 7 | No. 8 | No. 9 |
| Initial mean particle | | 2,000 | 1,500 | 2,800 | 2,000 | 1,000 | 1,000 | 1,000 | 700 | 500 |
| diameter (μm) (Note 1) | | | | | | | | | | |
| TI value | Initial stage | 2.0 | 1.8 | 2.2 | 2.4 | 2.6 | 2.8 | 2.6 | 3.0 | 3.5 |
| (Note 2) | After storage | 3.5 | 3.6 | 3.0 | 3.6 | 2.8 | 3.0 | 3.1 | 3.0 | 3.5 |
| | (40° C., 4 weeks) | | | | | | | | | |

| | | | | | | | | | |
|---|---|---|---|---|---|---|---|---|---|
| Storage stability | B | B | B | B | A | A | A | A | A |
| (Note 10) | | | | | | | | | |

### Comparative Examples 1 to 6

Following the procedure of Example 1, pigment dispersion pastes No. 10 to No. 15 were stored, and the conditions and TI value after storage (Note 10) were determined.

TABLE 4

| | | Comp. | Comp. | Comp. | Comp. | | Comp. |
|---|---|---|---|---|---|---|---|
| | | Ex. 1 | Ex. 2 | Ex. 3 | Ex. 4 | Comp. Ex. 5 | Ex. 6 |
| Pigment dispersion | | No. 10 | No. 11 | No. 12 | No. 13 | No. 14 | No. 15 |
| paste | | | | | | | |
| Initial mean | | 2,800 | 2,500 | 2,500 | 2,500 | 2,500 | 3,000 |
| particle diameter | | | | | | | |
| (μm) (Note 1) | | | | | | | |
| TI value | Initial | 1.8 | 3.6 | 3.8 | 3.8 | 3.0 | 4.1 |
| (Note 2) | stage | | | | | | |
| | After | 4.5 | 4.1 | 4.2 | 4.5 | 4.2 | Not |
| | storage | | | | | | measurable |
| | (40° C., | | | | | | |
| | 4 weeks) | | | | | | |

| | | | | | | |
|---|---|---|---|---|---|---|
| Storage stability | D | D | D | D | D | D |
| (Note 10) | | | | | | |

(Note 10): Storage stability: 500 g of each pigment dispersion paste after storage was placed in a glass vial with a lid and stored at 10° C. for 4 weeks; and the conditions after storage were observed and evaluated according to the following criteria.
A: The pigment dispersion paste was returned to the original state upon stirring, posing no problems.
B: The pigment dispersion paste had a cake layer formed of settled pigment, but was returned to the original state by stirring for 1 hour or less.
C: The pigment dispersion paste had a cake layer formed of settled pigment, but was returned to the original state by stirring for 1 to 5 hours.
D: The pigment dispersion paste had a cake layer formed of settled pigment, and agglomerates of pigment remained in the pigment dispersion paste even after stirring for more than 5 hours.

### Production of Cationic Electrodeposition Coating Composition

### Production Example 12

### Production of Base Resin No. 1

In a reactor equipped with a thermometer, thermostat, stirrer, and reflux condenser, 380 parts of jER828EL (an epoxy resin produced by Japan Epoxy Resin Co., Ltd., epoxy equivalent: about 190) and 137 parts of bisphenol A were placed, and 0.26 parts of N-benzyldimethylamine was added while heating at 100° C., and the resulting mixture was heated to 120° C. and reacted for about 2 hours.

Thereafter, 120 parts of methyl isobutyl ketone was added, followed by cooling to 80° C. Then, 14 parts of methyl isobutyl diketimine of diethylenetriamine (75% solution in methyl isobutyl ketone) and 57 parts of N-ethylmonoethanolamine were added, and the resulting mixture was heated to 100° C. and reacted for about 5 hours. Thereafter, 41 parts of propylene glycol methyl ether was added to thereby obtain base resin No. 1 with a solids content of 80%.

### Production Example 13

### Production of Base Resin No. 2

In a separable flask with an internal volume of 2 L equipped with a thermometer, reflux condenser, and stirrer, 240 parts of 50% formalin, 55 parts of phenol, 101 parts of 98% industrial sulfuric acid, and 212 parts of meta-xylene were placed and reacted at 84 to 88° C. for 4 hours. After completion of the reaction, the reaction mixture was allowed to stand to separate the resin phase and aqueous sulfuric acid phase, and the resin phase was washed with water 3 times. Unreacted meta-xylene was stripped for 20 minutes at 20 to 30 mmHg and 120 to 130° C., to obtain 240 parts of phenol-modified xylene-formaldehyde resin with a viscosity of 1,050 centipoise (25° C.).

In another flask, 1,000 parts of jER828ELs-(trade name an epoxy resin produced by Japan Epoxy Resin Co., Ltd., epoxy equivalent: 190, molecular weight: 350), 400 parts of bisphenol A, and 0.2 parts of dimethylbenzylamine were added and reacted at 130° C. until the epoxy equivalent became 750.

Subsequently, 300 parts of phenol-modified xylene-formaldehyde resin, 140 parts of diethanolamine, and 65 parts of ketimine of diethylenetriamine were added and reacted at 120° C. for 4 hours, and then 420 parts of ethylene glycol monobutyl ether was added, to thereby obtain a xylene-formaldehyde resin-modified, amino group-containing epoxy resin with a solids content of 80% as base resin No. 2.

### Production Example 14

### Production of Blocked Polyisocyanate Curing Agent

270 parts of Cosmonate M-200 (trade name of crude MDI produced by Mitsui Chemicals, Inc.) and 25 parts of methyl isobutyl ketone were added to a reactor and heated to 70° C. Fifteen parts of 2,2-dimethylolbutanoic acid was gradually added thereto, and 118 parts of ethylene glycol monobutyl ether was then added dropwise. After performing a reaction at 70° C. for 1 hour, the reaction mixture was cooled to 60° C., and 152 parts of propylene glycol was added.

The mixture was sampled over time while the temperature was maintained; when no absorption by unreacted isocyanate groups was observed by infrared absorption spectrometry, a blocked polyisocyanate curing agent having a resin solids content of 90% was obtained.

### Production Example 15

### Production of Emulsion No. 1

87.5 parts (solids: 70 parts) of the base resin No. 1 obtained in Production Example 12, 33.3 parts (solids: 30 parts) of the blocked polyisocyanate curing agent obtained in Production Example 14, and 15 parts of 10% acetic acid were mixed and uniformly stirred. Thereafter, 158.3 parts of deionized water was added dropwise over about 15 minutes with vigorous stirring to thereby obtain emulsion No. 1 with a solids content of 34% for cathodic electrodeposition.

### Production Example 16

### Production of Emulsion No. 2

An 87.5 part quantity (solids: 70 parts) of base resin No. 2 obtained in Production Example 13, 33.3 parts (solids: 30 parts) of the blocked polyisocyanate curing agent obtained in Production,Example 14, and 15 parts of 10% acetic acid were mixed and uniformly stirred. Thereafter, 158.3 parts of deionized water was added dropwise over about 15 minutes with vigorous stirring to thereby obtain emulsion No. 2 with a solids content of 34% for cathodic electrodeposition.

### Example 10

### Production of Cationic Electrodeposition Coating Composition No. 1

43.8 parts (solids: 17.5 parts) of pigment dispersion paste No. 1, 5.6 parts of 10% acetic acid, and 440.0 parts of deionized water were added to 294 parts (solids: 100 parts) of emulsion No. 1 obtained in Production Example 15 and uniformly mixed to thereby obtain cationic electrodeposition coating composition No. 1 with a solids content of 20%.

### Examples 11 to 21

### Production of Cationic Electrodeposition Coating Composition No. 2 to No. 12

Cationic electrodeposition coating compositions No. 2 to No. 12 with the formulations shown in Table 5 were obtained in the same manner as Example 10. The table also shows the results of testing the coating compositions by the methods described hereinafter.

TABLE 5

| | | Ex. 10 | Ex. 11 | Ex. 12 | Ex. 13 | Ex. 14 | Ex. 15 |
|---|---|---|---|---|---|---|---|
| Cation electrodeposition coating composition | | No. 1 | No. 2 | No. 3 | No. 4 | No. 5 | No. 6 |
| Formulation | Emulsion No. 1 | 294 | 294 | 294 | 294 | 294 | 294 |
| | | (100) | (100) | (100) | (100) | (100) | (100) |
| | Emulsion No. 2 | | | | | | |
| | Pigment dispersion paste No. 1 | 43.8 | | | | | |
| | | (17.5) | | | | | |
| | Pigment dispersion paste No. 2 | | 44.5 | | | | |
| | | | (17.8) | | | | |
| | Pigment dispersion paste No. 3 | | | 43.8 | | | |
| | | | | (17.5) | | | |
| | Pigment dispersion paste No. 4 | | | | 43.8 | | |
| | | | | | (17.5) | | |
| | Pigment dispersion paste No. 5 | | | | | 43.75 | |
| | | | | | | (17.5) | |
| | Pigment dispersion paste No. 6 | | | | | | 44.3 |
| | | | | | | | (17.7) |
| | Pigment dispersion paste No. 7 | | | | | | |
| | Pigment dispersion paste No. 8 | | | | | | |
| | Pigment dispersion paste No. 9 | | | | | | |
| | 10% Acetic acid | 5.6 | 5.6 | 5.6 | 5.6 | 5.6 | 5.6 |
| | Deionized water | 440.0 | 441.2 | 440.0 | 440.0 | 440.0 | 440.8 |
| | 15% Electrodeposition bath | 783.3 | 785.3 | 783.3 | 783.333 | 783.3 | 784.7 |
| | | (117.5) | (117.8) | (117.5) | (117.5) | (117.5) | (117.7) |
| Performance evaluation | | | | | | | |
| Re- | Filtration residue mg/l (Note 11) | B | B | A | A | A | A |
| dispersibility | Finish on L-shaped substrate (Note 12) | B | B | B | B | B | B |
| Warm salt water resistance (Note 13) | | B | B | B | B | B | B |
| Impact resistance (Note 14) | | B | B | B | B | B | B |
| | | Ex. 16 | Ex. 17 | Ex. 18 | Ex. 19 | Ex. 20 | Ex. 21 |
| Cation electrodeposition coating composition | | No. 7 | No. 8 | No. 9 | No. 10 | No. 11 | No. 12 |
| Formulation | Emulsion No. 1 | 294 | 294 | 294 | | | |
| | | (100) | (100) | (100) | | | |
| | Emulsion No. 2 | | | | 294 | 294 | 294 |
| | | | | | (100) | (100) | (100) |
| | Pigment dispersion paste No. 1 | | | | | | |
| | Pigment dispersion paste No. 2 | | | | | | |
| | Pigment dispersion paste No. 3 | | | | 43.8 | | |
| | | | | | (17.5) | | |
| | Pigment dispersion paste No. 4 | | | | | 43.8 | |
| | | | | | | (17.5) | |
| | Pigment dispersion paste No. 5 | | | | | | 43.8 |
| | | | | | | | (17.5) |
| | Pigment dispersion paste No. 6 | | | | | | |
| | Pigment dispersion paste No. 7 | 44.5 | | | | | |
| | | (17.8) | | | | | |
| | Pigment dispersion paste No. 8 | | 45.0 | | | | |
| | | | (18.0) | | | | |
| | Pigment dispersion paste No. 9 | | | 46.8 | | | |
| | | | | (18.7) | | | |
| | 10% Acetic acid | 5.6 | 5.6 | 5.6 | 5.6 | 5.6 | 5.6 |
| | Deionized water | 441.2 | 442.1 | 445.0 | 440.0 | 440.0 | 440.0 |
| | 15% Electrodeposition bath | 785.3 | 786.7 | 791.3 | 783.3 | 783.3 | 783.3 |
| | | (117.8) | (118.0) | (118.7) | (117.5) | (117.5) | (117.5) |
| Performance evaluation | | | | | | | |
| Re- | Filtration residue mg/l (Note 11) | A | A | A | B | B | B |
| dispersibility | Finish on L-shaped substrate (Note 12) | B | A | A | B | B | B |

| | | | | | | |
|---|---|---|---|---|---|---|
| Warm salt water resistance (Note 13) | B | B | B | A | A | A |
| Impact resistance (Note 14) | B | B | B | A | A | A |

In the formulations, the numerals indicate parts by mass, and the parenthesized numerals indicate solids contents.

### Comparative Examples 11 to 16

### Production of Cationic Electrodeposition Coating Compositions No. 13 to No. 18

Cationic electrodeposition coating compositions No. 13 to No. 18 with the formulations shown in Table 6 were obtained in the same manner as Example 10. The table also shows the results - of testing the coating compositions by the methods described hereinafter.

TABLE 6

| | | Comp. Ex. | Comp. Ex. | Comp. Ex. | Comp. Ex. | Comp. Ex. | Comp. Ex. |
|---|---|---|---|---|---|---|---|
| | | 11 | 12 | 13 | 14 | 15 | 16 |
| Cationic electrodeposition coating composition | | No. 13 | No. 14 | No. 15 | No. 16 | No. 17 | No. 18 |
| Formulation | Emulsion No. 1 | 294 | 294 | 294 | 294 | 294 | 294 |
| | | (100) | (100) | (100) | (100) | (100) | (100) |
| | Pigment dispersion paste No. 10 | 43.3 | | | | | |
| | | (17.3) | | | | | |
| | Pigment dispersion paste No. 11 | | 45.8 | | | | |
| | | | (18.3) | | | | |
| | Pigment dispersion paste No. 12 | | | 45.8 | | | |
| | | | | (18.3) | | | |
| | Pigment dispersion paste No. 13 | | | | 45.8 | | |
| | | | | | (18.3) | | |
| | Pigment dispersion paste No. 14 | | | | | 79.3 | |
| | | | | | | (31.7) | |
| | Pigment dispersion paste No. 15 | | | | | | 104.3 |
| | | | | | | | (41.7) |
| | 10% Acetic acid | 5.6 | 5.6 | 5.6 | 5.6 | 5.6 | 5.6 |
| | Deionized water | 776.4 | 436.6 | 436.6 | 436.6 | 505.8 | 554.1 |
| | 15% Electrodeposition bath | 782 | 782 | 782 | 782 | 884.7 | 958 |
| | | (117.3) | (117.3) | (117.3) | (117.3) | (132.7) | (143.7) |

| Performance evaluation | | | | | | | |
|---|---|---|---|---|---|---|---|
| Re-dispersibility | Filtration residue mg/l (Note 11) | C | D | D | D | D | D |
| | Finish on L-shaped substrate (Note 12) | C | D | D | D | D | D |

| | | | | | | |
|---|---|---|---|---|---|---|
| Warm salt water resistance (Note 13) | B | C | C | C | D | D |
| Impact resistance (Note 14) | B | C | C | C | D | D |

In the formulations, the numerals indicate parts by mass, and the parenthesized numerals indicate solids contents.

### Preparation of Test Plate

A cold-rolled dull steel sheet (0.8×150×70 mm) treated by chemical conversion with Palbond #3020 (a zinc phosphate treatment agent produced by Nihon Parkerizing Co., Ltd.) was immersed in each of the cationic electrodeposition coating compositions obtained in Examples 10 to 21 and Comparative Examples 11 to 16. Using the steel sheet as the cathode, an electrodeposition coating film with a thickness of 20 μm was formed, washed with water, and baked at 170° C. for 20 minutes to thereby obtain a test plate. Tables 5 and 6 show the results of the tests of the coating compositions and the performance tests of the test plates.

Note 11: Filtration residue: Stirring of cationic electrodeposition coating composition was stopped for 24 hours, and then performed again for 1 hour. The resulting coating composition was filtered through a 400-mesh filter screen, and the amount of residue (mg/L) was measured.
A: The amount of residue was less than 1 mg/L.
B: The amount of residue was 1 mg/L to less than 10 mg/L.
C: The amount of residue was 10 mg/L to less than 20 mg/L.
D: The amount of residue was 20 mg/L or more.

Note 12: Finish on L-shaped substrate: Stirring of cationic electrodeposition coating composition was stopped for 24 hours, and then performed again for 1 hour. Electrodeposition coating with the resulting coating composition was performed for 3 minutes using a test plate bent into an L shape as the substrate, and a level plane (L-shaped plane) was observed.
A: Good without problems.
B: Slight reduction in gloss of the coating film, posing no problem as a product.
C: Visible reduction in cissing resistance and roundness of the coating film.
D: Marked reduction in cissing resistance, roundness, and gloss of the coating film.

Note 13: Warm salt water resistance: Crosscuts were formed with a knife on the coated sheets obtained in the Examples and Comparative Examples, immersed in 5% salt water at 55° C. for 10 days. The results were evaluated according to the following criteria.
A: The maximum width of rusting or blistering was less than 2 mm from the cut (on one side).
B: The maximum width of rusting or blistering was not less than 2 mm and less than 3 mm from the cut (on one side).
C: The maximum width of rusting or blistering was not less than 3 mm and less than 4 mm from the cut (on one side).
D: The maximum width of rusting or blistering was not less than 4 mm from the cut (on one side).

Note 14: Impact resistance: The test was performed using a Dupont impact tester under an impact point diameter of ½ inch, a weight drop height of 50 cm, and a measuring atmosphere at 20° C.
A: No abnormalities on both sides.
B: Fine cracks were observed to a slight extent on back side.
C: Fine cracks were observed to a slight extent on both sides.
D: Large cracks were observed on both sides.

### INDUSTRIAL APPLICABILITY

The pigment dispersion paste of the present invention can eliminate the need for stirring during storage, and an electrodeposition coating composition comprising the pigment dispersion paste of the present invention enables energy saving in a coating line.

1. A pigment dispersion paste for electrodeposition coating compositions, comprising (i) a pigment-dispersing resin, (ii) a pigment component, (iii) a cellulose (A), (iv) a hydroxyalkyl imidazoline compound (B) and/or a compound (C), and (v) water;
the pigment dispersion paste comprising, per 100 parts by mass of the solids of the pigment-dispersing resin, 0.1 to 1,000 parts by mass of the pigment component, 0.1 to 25 parts by mass of the cellulose (A), and 0.1 to 5 parts by mass of the hydroxyalkyl imidazoline compound (B) represented by Formula (1) and/or 0.1 to 5 parts by mass of the compound (C) represented by Formula (2); and
the pigment dispersion paste, when adjusted to a solids concentration of 40 mass %, having an TI value of 1.8 to 4.0 as measured by the pigment test method of JIS K 5101-6-2: 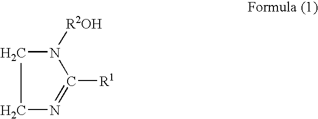
wherein R¹ is a C₆₋₃₂ hydrocarbon group and R² is a C₂₋₆ alkylene group; 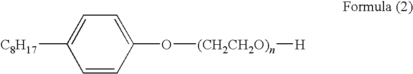
wherein n is an integer from 11 to 16.

2. The pigment dispersion paste according to claim 1, wherein the pigment dispersion paste comprises, per 100 parts by mass of the solids of the pigment-dispersing resin, 0.1 to 1,000 parts by mass of the pigment component, 0.1 to 25 parts by mass of the cellulose (A), and 0.1 to 5 parts by mass of the hydroxyalkyl imidazoline compound (B) represented by Formula (1); and wherein the pigment dispersion paste, when adjusted to a solids concentration of 40 mass %, has an TI value of 1.8 to 4.0 as measured by the pigment test method of JIS K 5101-6-2.

3. The pigment dispersion paste according to claim 1, wherein the pigment dispersion paste comprises, per 100 parts by mass of the solids of the pigment-dispersing resin, 0.1 to 1,000 parts by mass of the pigment component, 0.1 to 25 parts by mass of the cellulose (A), and 0.1 to 5 parts by mass of the compound (C) represented by Formula (2); and wherein the pigment dispersion paste, when adjusted to a solids concentration of 40 mass %, has an TI value of 1.8 to 4.0 as measured by the pigment test method of JIS K 5101-6-2.

4. The pigment dispersion paste according to claim 1, wherein the pigment dispersion paste comprises, per 100 parts by mass of the solids of the pigment-dispersing resin, 0.1 to 1,000 parts by mass of the pigment component, 0.1 to 25 parts by mass of the cellulose (A), 0.1 to 5 parts by mass of the hydroxyalkyl imidazoline compound (B) represented by Formula (1), and 0.1 to 5 parts by mass of the compound (C) represented by Formula (2); and wherein the pigment dispersion paste, when adjusted to a solids concentration of 40 mass %, has an TI value of 1.8 to 4.0 as measured by the pigment test method of JIS K 5101-6-2.

5. The pigment dispersion paste according to claim 1, wherein the cellulose (A) is a fine cellulose dispersion having a mean particle diameter of 0.01 to 6 μm.

6. The pigment dispersion paste according to claim 1, wherein the cellulose (A) is a cellulose composite dispersion (a) comprising a fine cellulose dispersion and a water-soluble gum and/or a hydrophilic substance.

7. The pigment dispersion paste according to claim 1, wherein, after storage at 40° C. for 4 weeks, the pigment dispersion paste, when adjusted to a solids concentration of 40 mass %, has an TI value of 1.8 to 4.0 as measured by the pigment test method of JIS K 5101-6-2.

8. The pigment dispersion paste according to claim 1, wherein the increase in the TI value of the pigment dispersion paste after storage at 40° C. for 4 weeks is 0.5 or less as compared with the TI value of the pigment dispersion paste before storage; and wherein the TI values before and after storage at 40° C. for 4 weeks are both within the range of 1.8 to 4.0.

9. The pigment dispersion paste according to claim 1, which has a solids content of 40 to 60 mass %.

10. The pigment dispersion paste according to claim 1, wherein particles present in the pigment dispersion paste have a mean particle diameter of 1 to 3,000 nm.

11. An electrodeposition coating composition comprising a base resin, a curing agent, and the pigment dispersion paste according to any one of claims 1 to 10 in an amount of 0.1 to 50 parts by mass on a solids basis per 100 parts by mass of the total solids content of the base resin and the curing agent.
